(19) United States
(12) Patent Application Publication
(10) Pub. No.: US 2003/0161914 A1
(43) Pub. Date: Aug. 28, 2003

(54) Novel caramel food ingredients, processes for the manufacture thereof, and nutritional procucts containing these caramels

(76) Inventors: Frances Sault, Dorval (CA); Dennis Jones, Shelburne, VT (US); Mel Warnecke, Goodlettsville, TN (US)

Correspondence Address: HELLER EHRMAN WHITE & MCAULIFFE LLP, 1666 K STREET,NW, SUITE 300, WASHINGTON, DC, 20006, US

(21) Appl. No.: 10/355,207

(22) Filed: Jan. 31, 2003

Related U.S. Application Data
(60) Provisional application No. 60/354,940, filed on Feb. 11, 2002.

(51) Int. Cl. A23G 1/00

(52) U.S. Cl. 426/103

(57) ABSTRACT

A caramel product comprising water, carbohydrate, wheat protein, oil and flavor is described along with methods of making the same. Also described is a nutritional bar comprising the caramel product of the present invention.

This application claims priority from U.S. Provisional application Serial No. 60/354,940, filed Feb. 11, 2002 and herein incorporated by reference.

### BACKGROUND OF THE INVENTION

1. Field of the Invention

The present invention relates to caramel food products wherein milk proteins are totally or partially replaced with proteins from other sources, preferably wheat glutens.

2. Description of Prior Art

Typically, caramel is manufactured from mixtures of milk proteins (both casein and lactalbumin) with carbohydrates and fat, whereby as a result of the high temperatures reached during the manufacturing process, which may be in the range of 93° C. to 150° C., the milk proteins react with the other ingredients, particularly the carbohydrate, to give the typical flavor, texture and color of caramel or toffee. The texture and firmness of such traditional caramels are determined by the final cook temperature, together with the specific ingredients used in the mix, while the flavor and color are due to the specific ingredients and the order of addition of these ingredients to the mix.

Such caramels, though often of excellent organoleptic properties when considered as stand-alone products such as toffees or chews, or as part of other products or covered with a coating, may be inappropriate nutritionally for incorporation into medical or nutritional foods such as nutrition bars. For example, the presence of milk proteins may be considered an obstacle with regard to allergenic potential, or for use in nutritional programs that require use only of plant proteins. Further, traditional caramels prepared using classical formulations and ingredients also do not have the optimal physical properties for use in certain types of nutritional bars in which one or more layers of caramel are laminated with a high-protein confectionery layer such as described in U.S. Pat. No. 6,299,929. Thus, a need exists for the preparation of caramels using non-milk proteins.

### SUMMARY OF THE INVENTION

The present invention relates to a caramel product comprising water, carbohydrate, wheat protein, oil and flavor, wherein the carbohydrate may be a simple sugar or a polymer thereof, such as a mono- or di-saccharide, or a tri-, tetra- or polysaccharide, a sugar alcohol or polymer thereof, such as sorbitol, maltitol, lactitol or hydrogenated dextrins or starch, random polymers of simple sugars such as polydextrose or oligofructose, including mixtures of any of the indicated carbohydrates, wherein the carbohydrate may be incorporated in dry form or as a concentrated liquid, and wherein said caramel product may also contain milk proteins or other proteins as well as such other ingredients as may conventionally be used in caramels and will be known to a skilled artisan, such as nuts, seeds, legumes or pieces thereof, including ground or milled nuts, seeds or legumes, and wherein the oil may consist of any edible oil or fat, including ingredients rich in fat such as chocolate liquor, chocolate, peanut butter, almond butter or other ground high-fat oil-seeds or oil nuts.

In another embodiment, the invention relates to a caramel product comprising water, carbohydrates such as sucrose, high maltose corn syrup and high fructose corn syrup, wheat gluten, an oily component such as fractionated palm kernel oil or chocolate liquor, or mixtures thereof, mono- or diglycerides, salt or other physiologically acceptable inorganic substances, lecithin, such as soya lecithin, and flavors such as natural vanilla flavor, wherein said caramel product does not comprise a milk protein.

In another embodiment, the invention relates to a caramel product comprising water, carbohydrates such as sucrose, high fructose corn syrup and high maltose corn syrup, deamidated wheat gluten, an oily component such as fractionated palm kernel oil or chocolate liquor, or mixtures thereof, mono- or diglycerides, salt or other physiologically acceptable inorganic substances, lecithin, such as soya lecithin, and natural vanilla flavor, wherein said caramel product does not comprise a milk protein.

In another embodiment, the invention relates to a method of producing a caramel product comprising the steps of (a) combining water, the carbohydrate component such as sucrose, maltose and fructose, the oily component, salt or other inorganic constituents, lecithin and flavor at about 60 degrees centigrade; (b) adding wheat gluten to the product of step (a) to create a homogenous blend; (c) heating the product of step (b) at about 150 degrees centigrade until the product is dark tan; and (d) cooling the product of step (c) to produce a semi-solid caramel product, wherein said method optionally includes adding a milk protein with the wheat gluten in step (b).

In another embodiment, the invention relates to a bar comprising a caramel described above, which may comprise a layer in a two-layer bar or may comprise one or more layers of a multilayer bar, or may be incorporated into the dough of a typical confectionery type bar prior to forming or shaping in replacement of some or all of the concentrated carbohydrate liquids typically used to manufacture such doughs.

### DESCRIPTION OF THE DRAWING

FIG. 1 is a schematic of the slab process.

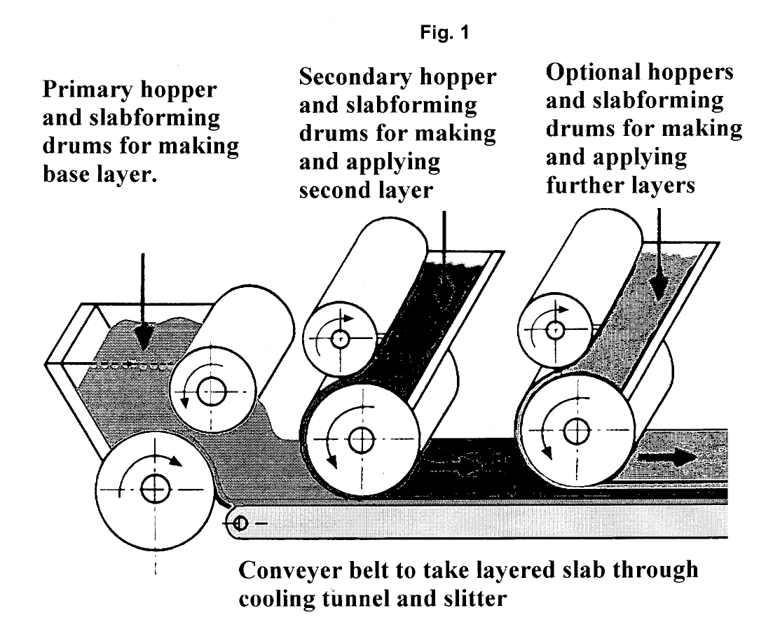

### DESCRIPTION OF PREFERRED EMBODIMENTS

Hitherto, replacement of the milk proteins by protein from other sources has not been successful, in that texture, flavor and color deviate from those considered acceptable for caramels. However, it has now been found that milk proteins may be wholly or partially replaced by isolated wheat protein (generally known as wheat “gluten”), and more specifically certain types of wheat gluten, which can function as excellent and, in terms of the physical properties of the resultant caramel, indistinguishable replacements for the traditional milk proteins. The glutens which can be used include both vital and devitalized, and the use of a so-called deamidated gluten is of particular merit.

The types of gluten that may be used are both vital and devitalized; and use of deamidated wheat gluten is of particular merit. Therefore, the invention provides caramel which sets conventionally such that it may be applied at room temperature as a layer on a confectionery base which may then be slit into ribbons and guillotined to form nutritional bars. Methods of producing nutritional bars are known to the skilled artisan.

Gluten proteins are storage proteins of wheat that are unique because they also are functional proteins. They do not have enzyme activity, but they are the only cereal proteins to form a strong, cohesive dough that will retain gas and produce light baked products. They can be easily isolated by removing starch and albumins/globulins by gently working a dough under a small stream of water. After washing, a rubbery ball is left, which is called gluten. After dispersion in water, this can be dried by flash-drying or spray-drying to give vital gluten, which retains its functional properties, or it may be dried under harsher conditions to give devitalized gluten. Devitalized gluten may also be obtained by enzymatic hydrolysis. Gluten is composed of two main groups of proteins: gliadins (prolamins) and glutenins (glutelins) in a ratio of approximately 2:3.

Wheat gluten is available as a by-product of the wheat starch industry and is used in food applications. The insolubility of gluten in aqueous solutions is one of the major limitations for its more extensive use in food processing. Gluten insolubility is due to the high concentration of nonpolar amino acid residues such as proline and leucine and the polar but non-ionisable residue glutamine, and to the low concentration of ionisable side chains such as lysine, arginine, glutamic acid and aspartic acid. The interactions between glutamine and asparagine side chains through hydrogen bonds play an important role in promoting association of gliadin and glutenin molecules to give the functionally complete gluten, and therefore modulation of these interactions are important for modification of gluten functionality.

Methods for modifying the solubility and functional properties of gluten have been developed. In particular, gluten modification via deamidation can be achieved in two ways, namely chemical deamidation (acid solubilisation) under acidic conditions and high temperature (Wu et al., 1976) or enzymatic treatment (Kato et al., 1987; Bollecker et al., 1990; Popineau and Thebaudin, 1990). Whether chemically or enzymatically induced, the deamidation of gluten proteins results in an increased charge density on the protein, causing changes in protein conformation due to electrostatic repulsion. These charge-induced conformational changes resulted in enhanced surface hydrophobicity due to the exposure of hydrophobic residues (Matsudomi et al., 1982). The increased surface hydrophobicity coupled with the presence of more negatively charged polar groups results in a modified protein with amphiphilic characteristics which makes an ideal surface active agent for use as an emulsifier or foam stabiliser. Even though surface hydrophobicity increases, protein solubility is also enhanced due to decreased protein-protein interactions. Levels of deamidation as low as 2-6% can enhance the functional properties of proteins (Matsudomi et al., 1985; Hamada and Marshall, 1989). Acid deamidation has been reported to leave behind an astringent mouth-feel, although this can be overcome by extraction with alkaline isopropanol and then isopropanol after deamidation (Finley, 1975). Deamidation is a hydrolytic reaction, similar to the peptide-bond cleavage reaction, which is catalyzed by proteases. It is catalyzed by acids and bases (nucleophiles), and requires a water molecule. The general acid, HA, catalyzes the reaction by protonating the amido —NH— leaving group of the Asn side chain. A general base (the conjugate base, A- or hydroxide ion) can attack the carbonyl carbon of the amido group or activate another nucleophile by abstraction of a proton for attack on the amide carbon. The transition state is inferred to be an oxyanion tetrahedral intermediate, whose stabilization by proton donors increases the rate of the reaction. The order of acid- and base-catalyzed steps varies with reaction conditions, particularly pH. The pH of maximum stability of Asn and Gln in peptides is around pH 6.0. Wright and Robinson (1982) showed how specific amino acid side chains are likely to function in catalyzing the deamidation of Asn and Gln in peptides and proteins. The Ser and Thr side chains can function as general acid groups, providing a proton to the leaving group or stabilizing the transition state. Asp, Glu, and His side chains are all nucleophiles at neutral pH, which can attack the carbonyl carbon of the amide side chain or function as general bases to activate nucleophiles.

The resultant caramels have the texture and color of traditional caramels, with a bland and reproducible cereal-like flavor devoid of burnt notes typical of highly cooked caramel made with milk proteins. By a “note” is meant a flavor. A “burnt note” is a flavor characteristic of burnt sugar or other burnt organic material. Furthermore, such novel caramels can be used as binders for cereals, nuts and similar particulate food ingredients to give products in which the particulate materials retain crispness for long periods of time, in excess of 6 months, without developing the softening and stickiness that occurs with traditional caramels, possibly due to better film-forming properties of the gluten proteins.

The caramels of the present invention have a wide range of applications. They can, for example, be modified to make soft, stand-up or flowing caramels, whereby stand-up caramels of a soft consistency can be used to form layers in the multiple layer nutritional bars, or novel caramels of the flowing type can be used as substitutes for some or all of the concentrated carbohydrate liquids conventionally used to manufacture nutritional bars of confectionery type. A caramel having “standability” is assessed by determining whether a layer of caramel maintains its shape upon cutting or whether it flows to cover a larger area.

The caramels of the invention have the advantage over conventional carbohydrate liquids in that they confer greater organoleptic and analytical shelf life, and furthermore contribute some protein to the overall nutritional profile, a contribution that would not be made by conventional carbohydrate liquids. The novel caramels may also be used to manufacture nutritional products totally devoid of milk proteins for use in dietary regimes where milk protein is undesirable or prohibited.

As will be obvious to those skilled in the art, the caramels of the present invention will have a wider range of applications than traditional caramels by virtue of their bland flavor, which permits flavor attributes to be added that would not be possible with traditional caramels of typical caramel flavor. For example, fruit flavor and fruit pieces may be incorporated into the caramel to give a pleasant fruity taste that can mimic a fruit puree, yet gives a product that can be formed into sheets and combined with confectionery type layers to give unique and unusual nutritional bars. To illustrate another utility, peanut pieces and peanut flavor may be used to create a crunchy peanut caramel that is indistinguishable from conventional peanut caramels, yet has longer organoleptic and analytical shelf life, since the peanuts do not absorb moisture and become soft and rancid.

Thus, in one embodiment, the invention relates to a caramel product comprising water, sugar, wheat protein, oil and flavor, wherein said caramel product does not contain milk protein or contains only a very small amount of milk protein. The caramel product may further comprise sucrose, corn syrup, wheat protein, vegetable oil, salt, lecithin and flavor. For instance, such caramel product may comprise about 0-25% of water, about 0-60% of sucrose, about 15 to 65% of corn syrup, about 0.5 to 20% of wheat protein, about 2 to 15% of vegetable oil, about 0 to 3% of salt, about 0 to 1.5% of lecithin and about 0 to 5% of flavor. The sucrose and said corn syrup of this caramel product may be replaced with sugar free polyol material, such as sorbitol, maltitol, and isomalt. The wheat protein of this caramel product may be wheat gluten. Such wheat gluten may be deamidated. In addition, this caramel product may further comprise one or more of crisp rice, raisins, dried cranberries, dried apples, almonds, or soy nuggets. The flavor may be natural or artificial vanilla, coffee, chocolate, peanut, fruit flavor, mint or spice. This caramel product may further comprise monoglycerides and diglycerides.

In another embodiment, the caramel product may comprise water, sucrose, high maltose corn syrup, high fructose corn syrup, wheat gluten, fractionated palm kernel oil, salt, soya lecithin and natural vanilla flavor but does not comprise milk protein or, in another embodiment comprises wheat gluten and milk protein. These products may further comprise crisp rice, raisins, dried cranberries, diced evaporated apples, almonds and soy nuggets.

In another embodiment, the caramel product of the invention comprises water, sucrose, high fructose corn syrup, high maltose corn syrup, deamidated wheat gluten, fractionated palm kernel oil, monoglycerides, salt, soya lecithin and natural vanilla flavor but does not comprise milk protein or, in another embodiment comprises wheat gluten and milk protein. These products may further comprise honey and almond butter.

In another embodiment, the invention relates to a method of producing a caramel product comprising the steps of (a) combining water, sucrose, maltose, fructose, oil, salt, lecithin and flavor at about 60 degrees centigrade; (b) adding wheat gluten to the product of step (a) to create a homogenous blend; (c) heating the product of step (b) at about 150 degrees centigrade until the product is dark tan; and (d) cooling the product of step (c) to produce a semi-solid caramel product, wherein said method does not include adding a milk protein to (b) or in another embodiment includes adding wheat gluten and milk protein to (b).

“Sugars” according to the invention may be any sugar acceptable in the industry. However, particularly suitable sugars are mono- and disaccharides. Other suitable sugars, such as high maltose corn syrup, comprise higher saccharides, such as tri- and tetrasaccharides.

In another embodiment, the invention relates to a bar comprising the above described caramel produced by the above described method. As will be understood by the skilled artisan, the caramel according to the invention is particularly suited to the manufacture of two- or multiplayer confectionery or nutritional bars. A “nutritional bar” is one that may be used as a dietary supplement or as a meal replacement. Nutritional bars may also contain vitamins, minerals and other nutrients. The bars of the present invention may be prepared by any method known to the skilled artisan. Such methods include but are not limited to cold extrusion methods. In one embodiment, a blend of confectionery materials is prepared in a dough mixer, and mixed until homogenous. A blend of liquids and fats is then made in a liquid mixer, such as a large Hobart mixer and stirring at high speed until homogenous. The liquid blend is then added to the powder blend in the dough mixer and further mixed until a homogenous plastic dough is obtained. This dough is placed in the hopper of a slab former, such as those manufactured by the German company Sollich, and passed between two drums, which may be cooled or warmed as required, and which for convenience may be referred to further in this specification as a “slabbing head”, to form a thin slab of material that is approximately as wide as the drum, for example 30″, though such equipment may be obtained in sizes capable of making slabs from a few inches to several feet wide. This slab is deposited on a moving conveyer belt such that it moves away from the forming drums at a speed corresponding to the rate of formation. At the same time, the caramel is warmed, for example from 50° C. to 80° C., and is applied to a third cooled drum rotating just above the moving slab of dough, such that a thin slab of caramel is continuously formed at a rate identical to that of the base slab, that can be separated from the drum and caused to adhere to the slab of dough, giving a slab of two layers, namely dough underneath and caramel on top, whereby the thicknesses of the two layers may be adjusted by firstly adjusting the gap between the drums which form the base layer, and secondly by adjusting the amount of material applied to the third roller, for example, by increasing or decreasing the gap between an optional hopper and the third roller, or if the material is applied directly from a pump, by adjusting pumping rate. The composite slab thus prepared is passed through a cooling tunnel, and then slit into ribbons by a set of rotating circular knives, the distance between which defines the width of the eventual bar. These ribbons are subsequently guillotined into bars of the required weight, which may, for example, be about 40 grams each, which are enrobed with a coating material as described above, for example a high protein compound chocolate coating, to give finished bars of about 50 grams, whereby it is understood that the weight and size of the bars are not limiting and may readily be adjusted as required. The bars are then wrapped in a Mylar foil. As will be obvious to a skilled artisan, it is also possible to move the drum that applies the caramel layer to a position in front of the confectionery slabbing layer, such that the caramel layer will eventually become the base layer of the finished bar. Preferably, the bars of the present invention are two-layer or multi-layer bars in which one of the layers is the caramel of the invention, whereby any enrobing is not considered as a layer. In one embodiment, multi-layer bars are made according to the process described above, but with additional “slabbing heads” and/or one or more additional drums rotating above the layer of slabbed dough, whereby such drums may be used to apply further layers of caramel or layers of confectionery material, such that further layers are consecutively added to the base slab as it proceeds away from the initial “slabbing head”. In a further embodiment, one or more of the layers may comprise particulate material that is sprinkled onto the slab or composite slab using equipment conventionally known as a nut or seed spreader, and which subsequently may or may not be covered by a further layer.

While the foregoing describes an embodiment whereby the bars according to the invention are manufactured by slab forming, it is also possible to manufacture such items using cold formers known as extruders with specially constructed dies, whereby the various layers are fed simultaneously to dies with internal divisions such that multiple thin “ropes” or strands of layered material are produced that can subsequently by guillotined or cut into bars. Such equipment is manufactured, for example, by the German company Bepex-Hutt, and though it has limited capability for multilayer bars, it offers the capability of creating a bar in which the layers are concentric, that is, the caramel layer may be surrounded by a concentric layer of confectionery material or vice versa.

The dough in such bars may comprise various proteins, carbohydrates (as powdered ingredients or as concentrated liquids), as well as other ingredients that may confer organoleptic attributes on the bar, including, but not limited to, peanut butter, dried coconut, peanut flour, cocoa powder, oils and fats, or particulate materials such as peanuts, soy beans, crisped rice, crisped soy protein or soy flour, and flavors. The bar may or may not be enrobed with a coating material such as a chocolate coating, optionally containing added protein, or a compound coating, which compound coatings may optionally comprise added proteins, and which may have the attributes of a chocolate, yogurt, peanut, carob or other type of coating material.

In one embodiment, the dough of the bar of the invention may be carbohydrate, protein or a combination of both. In one example, the carbohydrate may be digestible carbohydrate alone or a mixture of digestible and poorly digestible carbohydrate or non-digestible carbohydrates or it may comprise only poorly digestible carbohydrate. The carbohydrate may be added as a solid, dry material or it may be used in a concentrated solution.

The protein may be a binding protein, filler protein or mixtures thereof. A binding protein may be any protein which has low absorption properties yet will emulsify and can create a matrix of hydration. Specific examples are soy proteins, whey protein, whole milk protein, pea protein, egg albumen and wheat gluten.

Filler proteins may be any protein which has been denatured by processing to a low level of functional activity. Examples of filler proteins are caseinates, certain types of soy or whey proteins, pea protein, wheat gluten and egg albumens. Filler proteins should have low functionality and low water absorption and low viscosity, in particular.

Binding and filler proteins are known to the skilled artisan and are further described in U.S. Pat. No. 6,432,457, which is hereby incorporated by reference.

In one example, the dough is a high protein dough. High protein doughs, wherein the percentage by weight of protein is higher than that of carbohydrate are described in U.S. Pat. Nos. 6,299,929 and 6,432,457, which are again incorporated herein by reference.

References:

Bollecker, S., Viroben, G., Popineau, Y. and Gueguen, J. (1990). Acid deamidation and enzymic modification at pH 10 of wheat gliadins: influence on their functional properties. Sci. Aliments 10; 343-356.

Finley, J. W. (1975). Deamidated Gluten: A potential fortifier for fruit juices. J. Food Sci. 40; 1283-1285.

Hamada, J. S. and Marshall, W. B. (1989). Preparation and functional properties of enzymatically deamidated soy proteins. J. Food Sci. 54; 598-601

Kato, A., Tanaka, A., Lee, Y., Matsudomi, N. and Kobayashi, K. (1987). Effects of deamidation with chymotrypsin at pH 10 on the functional properties of proteins. J. Agric. Food Chem. 35; 285-288.

Matsudomi, N., Kato, A. and Kobayashi, K. (1982). Conformational and surface properties of deamidated gluten. Agric. Biol. Chem. 46; 1583-1586.

Matsudomi, N., Sasaki, T., Kato, A. and Kobayashi, K. (1985). Conformational changes and functional properties of acid-modified soy protein. Agric. Biol. Chem. 49; 1251-1256.

Popineau, Y. and Thebaudin, J. Y. (1990). Functional properties of enzymatically hydrolyzed glutens. In “Gluten Protein” (Eds. Bushuk, W. and Tkachuk, R.), AACC: St Paul, Minn.

Wright, H. T. and Robinson, A. B. (1982). Cryptic amidase active sites catalyze deamidation in proteins. In: “From Cyclotrons to Cytochromes”. (Eds. Kaplan, N. O. and Robinson, A. B.), Academic Press, New York.

Wu C. H., Shuryo, N. and Powrie, W. D. (1976). Preparation and properties of acid solubilized gluten. J. Agric. Food Chem. 24; 504-5 10.

The references and patents cited above and throughout this specification are herewith incorporated by reference.

### EXAMPLES

The invention is further illustrated by the following examples, without limitation thereto:

### Example 1

A novel caramel was prepared in the laboratory to the following formulation:

| | | |
|---|---|---|
| Water | 66.2 | grams |
| Sucrose | 165.4 | grams |
| High maltose corn syrup | 411.0 | grams |
| High fructose corn syrup | 224.4 | grams |
| Wheat gluten | 30.7 | grams |
| Fractionated palm kernel oil | 26.2 | grams |
| Salt | 2.5 | grams |
| Soya lecithin | 1.4 | grams |
| Natural vanilla flavor | 2.2 | grams |

All the ingredients except the wheat gluten were blended together and heated to 60° C. to dissolve the dry ingredients and melt the fat. The wheat gluten was then added slowly with stirring to the mix. Once a homogenous blend was obtained, the whole was further heated to 122° C. with stirring until the color changed to a dark tan. The caramel was allowed to cool, giving a semi-solid finished product that was flowable at temperatures above 60° C., and could be sheeted to give flexible layers that did not crack when deformed at room temperature.

### Example 2:

A mixture of fruits, cereal products and soy nuggets was prepared by gentle mixing according to the following formulation:

| | | |
|---|---|---|
| Crisp rice | 150.0 | grams |
| Raisins | 150.0 | grams |
| Dried cranberries | 75.0 | grams |
| Diced evaporated apples | 75.0 | grams |
| Almonds | 50.0 | grams |
| Soy nuggets | 50.0 | grams |

This blend (500 grams) of particulate ingredients was then carefully mixed with 220 grams of the novel caramel from Example 1 that had been heated to 79° C. On cooling, the blended product was formed into bars. Comparison of the bars at time 0 with bars kept at room temperature for one month showed no change in organoleptic parameters.

### Example 3

A novel caramel was prepared in the laboratory to the following formulation:

| | | |
|---|---|---|
| Water | 246.0 | grams |
| Sucrose | 597.0 | grams |
| High fructose corn syrup | 795.0 | grams |
| High maltose corn syrup | 147.0 | grams |
| Deamidated wheat gluten | 110.6 | grams |
| Fractionated palm kernel oil | 345.0 | grams |
| Monoglycerides | 16.5 | grams |
| Salt | 9.9 | grams |
| Soya lecithin | 15.1 | grams |
| Natural vanilla flavor | 17.9 | grams |

The sugar, salt and wheat gluten were blended until homogenous. The remaining ingredients with the exception of the palm kernel oil, lecithin and vanilla flavor were then mixed and heated to 60° C., after which the gluten/sugar/salt mixture was slowly added with stirring until homogenous. At this point, the fat and lecithin were added, and the whole heated to 122° C. with stirring until the solids content reached 89% and the color changed to a typical caramel color. The resultant caramel had a good caramel flavor and texture, was well emulsified, showed good binding properties, and could be held at 55° C. without any separation of fat occurring. A repeat trial of a pilot batch showed identical results.

### Example 4

Caramel prepared on a pilot scale as in Example 1, 28.000 kg, was melted in a kettle. After melting, the caramel was cooled to 55° C., and 6.000 kg of peanut pieces was added with stirring. The mixture was stirred continuously and held at 55° C., resulting in a homogenous dispersion of the peanut pieces.

A blend of dry materials was prepared in a low-shear dough mixer, according to the following composition, and mixed until homogenous.

| INGREDIENT: | WEIGHT IN KILOGRAMS: |
|---|---|
| Acid casein | 8.410 |
| Gelatin powder | 5.806 |
| Soy protein isolate | 3.342 |
| Whey protein isolate | 1.132 |
| Peanut flour | 1.724 |
| Vitamin and mineral premix | 1.046 |

A blend of liquids and fats was made according to the composition below, by placing the indicated amounts of materials in a large Hobart mixer and stirring at high speed until homogenous.

| INGREDIENT: | WEIGHT IN KILOGRAMS: |
|---|---|
| Glycerine USP | 9.728 |
| Maltitol syrup | 3.034 |
| Corn syrup | 2.194 |
| Peanut butter | 1.189 |
| Water | 1.132 |
| Flavors | 1.704 |
| Special fat preparation | 0.466 |
| Lecithin | 0.294 |

The liquid blend was then added to the powder blend in the dough mixer and further mixed until a homogenous plastic dough was obtained. his dough was placed in the hopper of a Sollich slab former and passed between two cooled drums to form a thin slab of material approximately 30″ wide. At the same time, the hot caramel and peanut blend was applied to a third cooled drum rotating just above the slab of dough, such that a thin slab of cooled caramel was formed that could be separated from the drum and caused to adhere to the slab of dough, giving a slab of two layers, namely dough underneath and caramel on top, of approximately equal thicknesses. The composite slab thus prepared was passed through a cooling tunnel, and then slit into ribbons by a set of rotating circular knives. These ribbons were subsequently guillotined into bars of about 40 grams each, which were enrobed with a high protein compound chocolate coating to give finished bars of about 50 grams. The bars were wrapped in a Mylar foil.

Using the caramel according to the invention, the caramel layer remained flexible but did not flow, and it could be cut without fracturing or tailing. Enrobed bars did not show leakage on storage. The nutritional profile of the bars thus made was:

Nutritional information per 50 gram unit:

| | |
|---|---|
| NUTRIENT: | CONTENT: |

| | | |
|---|---|---|
| Protein | 14.700 | g |
| Carbohydrate, total | 22.800 | g |
| Fat | 7.400 | g |
| Moisture | 3.400 | g |
| Total dietary fibre | 0.700 | g |
| Kilocalories (Atwater) | 210 | Keal |
| Kilojoules | 878 | Kj |
| Cholesterol | I | mg |
| Saturated fat | 4.200 | g |
| Mono-unsaturated fat | 1.600 | g |
| Poly-unsaturated fat | 1.010 | g |
| Total omega-3 EFAs | 0.060 | g |
| Total omega-6 EFAs | 0.950 | g |
| Linoleic acid | 0.950 | g |
| Potassium | 95 | mg |
| Sodium | 89 | mg |
| Calcium | 100 | mg |
| Phosphorus | 138 | mg |
| Vitamin A | 2500 | IU |
| Vitamin D | 80 | IU |
| Vitamin E | 30.000 | IU |
| Vitamin C | 60.000 | mg |
| Thiamine | 0.650 | mg |
| Riboflavin | 0.550 | mg |
| Niacin | 9.200 | mg |
| Vitamin B6 | 0.600 | mg |
| Vitamin B 12 | 1.500 | meg |
| Folate | 80 | meg |
| Biotin | 60 | mcg |
| Pantothenate | 2.000 | mg |
| Iron | 2.200 | mg |
| Iodine | 45 | mcg |
| Magnesium | 40 | mg |
| Copper | 0.450 | mg |
| Zinc | 3.250 | mg |
| Manganese | 1.000 | mg |

### Example 5

A blend of liquids and fats was made according to the composition below, by placing the indicated amounts of materials in a large Hobart mixer and stirring at high speed until homogenous. The caramel was warmed to 50° C. before adding.

| INGREDIENT: | WEIGHT IN KILOGRAMS: |
|---|---|
| Caramel (from Example 3) | 17.020 |
| Honey | 10.012 |
| High fructose corn syrup | 9.011 |
| Almond butter | 4.000 |
| Special fat preparation | 1.001 |
| Lecithin | 0.501 |
| Flavor | 0.200 |

A blend of dry materials was prepared in a low-shear dough mixer, according to the following composition, and mixed until homogenous.

| INGREDIENT: | WEIGHT IN KILOGRAMS: |
|---|---|
| Diced soya beans | 18.522 |
| Soy protein isolate | 13.083 |
| Oat flakes | 7.008 |
| Soy nuggets | 5.506 |
| Fructose | 4.405 |
| Calcium caseinate | 4.375 |
| Almond pieces | 3.000 |
| Whey protein concentrate | 2.002 |
| Vitamin and mineral preparation | 0.352 |

The liquid blend was then mixed with the blended powders and further mixed until a dough was obtained. This dough was placed in the hopper of a 16″ APV confectionery former and shaped into ribbons (cross-section 1.25″×0.625″) which were guillotined to give bars of about 50 grams each. After cooling, the bars were immediately wrapped in foil, without enrobing, to give a nutritious protein snack. The texture of the bars was significantly improved over that of comparable bars made without caramel.

The nutritional profile of the bars was as indicated.

Nutritional information per 50 gram unit:

| | |
|---|---|
| NUTRIENT: | CONTENT: |

| | | |
|---|---|---|
| Protein | 15.400 | g |
| Carbohydrate, total | 22.300 | g |
| Fat | 6.000 | g |
| Moisture | 3.900 | g |
| Total dietary fibre | 1.900 | g |
| Kilocalories (Atwater) | 202 | Kcal |
| Kilojoules | 844 | Kj |
| Cholesterol | 2 | mg |
| Saturated fat | 1.280 | g |
| Mono-unsaturated fat | 2.380 | g |
| Poly-unsaturated fat | 2.020 | g |
| Total omega-3 EFAs | 0.220 | g |
| Total omega-6 EFAs | 1.800 | g |
| Linoleic acid | 1.800 | g |
| Potassium | 187 | mg |
| Sodium | 148 | mg |
| Calcium | 83 | mg |
| Phosphorus | 179 | mg |
| Vitamin A | 1250 | IU |
| Vitamin D | 100 | IU |
| Vitamin E | 7.500 | IU |
| Vitamin C | 15.000 | mg |
| Thiamine | 0.500 | mg |
| Riboflavin | 0.580 | mg |
| Niacin | 5.000 | mg |
| Vitamin B6 | 0.500 | mg |
| Vitamin B 12 | 1.500 | mcg |
| Folate | 100 | mcg |
| Biotin | 80 | mcg |
| Pantothenate | 2.500 | mg |
| Iron | 6.680 | mg |
| Iodine | 40 | mcg |
| Magnesium | 40 | mg |
| Copper | 0.750 | mg |
| Zinc | 5.000 | mg |
| Manganese | 1.000 | mg |

### Example 6:

A high-fat caramel containing carbohydrate only in the form of sugar alcohols was prepared as follows:

The following ingredients were weighed out:

| INGREDIENT: | WEIGHT IN KILOGRAMS: |
|---|---|
| Water | 4.90 |
| Maltitol syrup | 63.71 |
| Salt | 0.24 |

These ingredients were added to a cooker (a heated vessel equipped with a stirrer), mixed, and the whole heated to 60 degrees Celsius (140 degrees Fahrenheit). To the heated, stirred mass was then slowly added, with stirring, a preblended mixture of 15.63 kg of crystalline sorbitol and 2.90 kg of wheat gluten (FP-600). In the meantime, a blend of 12.28 kg fractionated palm kernel oil and 0.13 kg soya lecithin was prepared by melting the palm kernel oil at 60 degrees Celsius and stirring in the lecithin until a homogenous liquid was obtained. The melted fat blend was held at this temperature until the water-maltitol-sorbitol-wheat gluten mixture was homogenous, whereupon the fat blend was then added to this mixture and the whole stirred until homogenous. At this point, the temperature was increased, with continued stirring, to 122 degrees Celsius (252 degrees Fahrenheit) and cooked at this temperature until the Brix solids was about 89%.

The mixture was then cooled to 93 degrees Celsius (200 degrees Fahrenheit) and 0.21 kg of natural vanilla flavor was stirred in. Stirring continued until a homogenous fluid mass resulted. This was further cooled to about 80 degrees Celsius, then discharged into polythene-lined drums for storage.

The nutrient composition of this caramel, expressed per 100 grams, was:

| | |
|---|---|
| NUTRIENT: | CONTENT: |

| | | |
|---|---|---|
| Protein | 2.296 | g |
| Carbohydrate, total | 71.917 | g |
| Fat | 12.482 | g |
| Moisture | 10.472 | g |
| Total dietary fibre | 0.000 | g |
| Kilocalories (Atwater) | 355 | Kcal |
| Kilojoules | 1488 | Kj |

Subsequently, this caramel was heated to 77 degrees Celsius (170 degrees Fahrenheit) and used to coat a cereal mixture.

### Example 7

A low-fat caramel containing carbohydrate only in the form of sugar alcohols was prepared as follows:

The following ingredients were weighed out:

| INGREDIENT: | WEIGHT IN KILOGRAMS: |
|---|---|
| Water | 5.00 |
| Maltitol syrup | 71.53 |
| Salt | 0.27 |

These ingredients were added to a cooker (a heated vessel equipped with a stirrer), mixed, and the whole heated to 60 degrees Celsius (140 degrees Fahrenheit). To the heated, stirred mass was then slowly added, with stirring, a preblended mixture of 17.54 kg of crystalline sorbitol and 3.26 kg of wheat gluten (FP-600). In the meantime, a blend of 2.01 kg fractionated palm kernel oil and 0.15 kg soya lecithin was prepared by melting the palm kernel oil at 60 degrees Celsius and stirring in the lecithin until a homogenous liquid was obtained. The melted fat blend was held at this temperature until the water-maltitol-sorbitol-wheat gluten mixture was homogenous, whereupon the fat blend was then added to this mixture and the whole stirred until homogenous. At this point, the temperature was increased, with continued stirring, to 122 degrees Celsius (252 degrees Fahrenheit) and cooked at this temperature until the Brix solids was about 89%.

The mixture was then cooled to 93 degrees Celsius (200 degrees Fahrenheit) and 0.23 kg of natural vanilla flavor was stirred in. Stirring continued until a homogenous fluid mass resulted. This was further cooled to about 80 degrees Celsius, then discharged into polythene-lined drums for storage.

The nutrient composition of this caramel, expressed per 100 grams, was:

| | |
|---|---|
| NUTRIENT: | CONTENT: |

| | | |
|---|---|---|
| Protein | 2.726 | g |
| Carbohydrate, total | 80.428 | g |
| Fat | 2.376 | g |
| Moisture | 11.212 | g |
| Total dietary fibre | 0.000 | g |
| Kilocalories (Atwater) | 295 | Kcal |
| Kilojoules | 1236 | Kj |

Subsequently, this caramel was heated to 77 degrees Celsius (170 degrees Fahrenheit) and used to coat a cereal mixture.

### Example 8

A medium-fat chocolate caramel containing carbohydrate only in the form of sugar alcohols was prepared in accordance with the method of example 6, except that the fractionated palm kernel oil was replaced by chocolate liquor, and the vanilla flavor was replaced by a natural chocolate flavor. The resulting caramel was a dark chocolate color and had a pleasing chocolate taste; it could also be used to coat a nut mixture.

The nutrient composition of this caramel, expressed per 100 grams, was:

| | |
|---|---|
| NUTRIENT: | CONTENT: |

| | | |
|---|---|---|
| Protein | 4.063 | g |
| Carbohydrate, total | 75.561 | g |
| Fat | 6.667 | g |
| Moisture | 10.521 | g |
| Total dietary fibre | 0.000 | g |
| Kilocalories (Atwater) | 326 | Kcal |
| Kilojoules | 1366 | Kj |

What we claim is:

1) A caramel product comprising water, carbohydrate, wheat protein, oil and flavor.

2) The caramel product of claim 1, further comprising salt and lecithin and wherein said carbohydrate is a simple sugar or a polymer thereof.

3) The caramel of claim 2, wherein said simple sugar is selected from the group consisting of, a monosaccharide, disaccharide, trisaccharide, tetrasaccharide, polysaccharide, a sugar alcohol and a mixture thereof.

4) The caramel of claim 2, wherein said polymer of said sugar is selected from the group consisting of sorbitol, maltitol, lactitol, hydrogenated dextrins, hydrogenated starch, a random polymer of a simple sugar and a mixture thereof.

5) The caramel of claim 4, wherein the random polymer of a simple sugar is a polydextrose or oligofructose.

6) The caramel of claim 1, wherein the carbohydrate is incorporated into said caramel in dry form.

7) The caramel of claim 1, wherein the carbohydrate is incorporated into said caramel as a concentrated liquid.

8) The caramel of claim 1, which further comprises a milk protein or other protein.

9) The caramel of claim 1, which further comprises another ingredient selected from the group consisting of nuts, seeds, legumes or pieces thereof.

10) The caramel of claim 1, wherein said oil is an edible oil or fat.

11) The caramel of claim 10, wherein said oil or fat may be in an ingredient selected from the group consisting of a chocolate liquor, chocolate, peanut butter, almond butter, ground high-fat oil-seeds and ground oil nuts.

12) The caramel product of claim 1, which further comprises salt and lecithin and said carbohydrate is sucrose and corn syrup and said oil is vegetable oil.

13) The caramel of claim 12, which comprises about 0-25% of water, about 0-60% of sucrose, about 15 to 65% of corn syrup, about 0.5 to 20% of wheat protein, about 2 to 15% of vegetable oil, about 0 to 3% of salt, about 0 to 1.5% of lecithin and about 0 to 5% of flavor.

14) The caramel product of claim 12, wherein said sucrose and said corn syrup is replaced with sugar free polyol material.

15) The caramel product of claim 14, wherein said sugar free polyol material is selected from the group consisting of sorbitol, maltitol, and isomalt.

16) The caramel product of claim 1, wherein said wheat protein is wheat gluten.

17) The caramel product of claim 16, wherein said wheat gluten is deamidated.

18) The caramel product of claim 1, further comprising one or more of crisp rice, raisins, dried cranberries, dried apples, almonds, or soy nuggets.

19) The caramel product of claim 1, wherein said flavor is selected from the group consisting of natural vanilla, coffee, chocolate, peanut, fruit flavor, mint and, spice.

20) The caramel product of claim 1, which further comprises monoglycerides and diglycerides.

21) The caramel product of claim 1, which does not comprise milk protein.

22) A caramel product comprising water, a carbohydrate, wheat gluten, oily component, a mono- or diglyceride, an inorganic substance, lecithin and flavor, wherein said product does not comprise a milk protein.

23) The caramel product of claim 22, wherein said oily component is selected from the group consisting of a fractionated palm kernel oil, chocolate liquor, and a mixture thereof.

24) The caramel product of claim 22, wherein said inorganic substance is salt.

25) The caramel product of claim 22, wherein said lecithin is soya lecithin and said flavor is natural vanilla.

26) A caramel product comprising water; a carbohydrate selected from the group consisting of a sucrose, a high fructose corn syrup, a high maltose corn syrup and a mixture thereof; deamidated wheat gluten; an oily component selected from the group consisting of a fractionated palm kernel oil, a chocolate liquor, and mixtures thereof; mono- or diglycerides, salt or other physiologically acceptable inorganic substance; lecithin; and natural vanilla flavor, wherein said caramel product does not comprise a milk protein.

27) The caramel product of claim 25, wherein said lecithin is soya lecithin.

28) The caramel product of claim 25, further comprising crisp rice, raisins, dried cranberries, diced evaporated apples, almonds and soy nuggets.

29) A caramel product comprising water, sucrose, high fructose corn syrup, high maltose corn syrup, deamidated wheat gluten, fractionated palm kernel oil, monoglycerides, salt soya lecithin and natural vanilla flavor, wherein said caramel product does not comprise milk protein.

30) The caramel product of claim 28, further comprising honey and almond butter.

31) A method of producing a caramel product comprising the steps of (a) combining water, sucrose, maltose, fructose, oil, salt, lecithin and flavor at about 60 degrees centigrade; (b) adding wheat gluten to the product of step (a) to create a homogenous blend; (c) heating the product of step (b) at about 150 degrees centigrade until the product is dark tan; and (d) cooling the product of step (c) to produce a semi-solid caramel product.

32) The method of claim 30, wherein said method does not include adding a milk protein.

33) The method of claim 30, wherein a milk protein is added to step (b).

34) A nutritional bar comprising a caramel of any one of claims 1 to 29.

35) The nutritional bar of claim 33, comprising a dough, wherein said caramel is a layer on said dough or is admixed in said dough.

36) The nutritional bar of claim 34 which is a multilayer bar.

37) A nutritional bar comprising crisp rice, raisins, dried cranberries, evaporated apples, almonds, soy nuggets and a caramel comprising water, sucrose, high fructose corn syrup, high maltose corn syrup, deamidated wheat gluten, fractionated palm kernel oil, monoglycerides, sale, soya lecithin, and natural vanilla flavor.
